(19) United States
(12) Patent Application Publication
(10) Pub. No.: US 2012/0139960 A1
(43) Pub. Date: Jun. 7, 2012

(54) REFLECTIVE COLOR FILTER, AND REFLECTIVE COLOR DISPLAY APPARATUS AND METHOD OF COLOR DISPLAY EMPLOYING THE SAME

(76) Inventors: ChangGyun SHIN, Anyang-si (KR); Moon Gyu HAN, Yongin-si (KR)

(21) Appl. No.: 13/204,798

(22) Filed: Aug. 8, 2011

(30) Foreign Application Priority Data
Dec. 7, 2010 (KR) 10-2010-0124228

(51) Int. Cl. G09G 5/10; G02B 5/22

(52) U.S. Cl. 345/690; 359/891

(57) ABSTRACT

A reflective color filter, and a reflective color display apparatus and a method for a reflective color display employing the reflective color filter is provided. The reflective color filter includes first and second photonic crystal areas which reflect light in a selection wavelength band from external light and include a tunable photonic crystal which tunes a photonic band gap corresponding to a frequency bandwidth reflecting light through stimulation. A controller provides stimulations to the first and second photonic crystal areas to adjust the photonic band gap of the tunable photonic crystal of the first and second photonic crystal areas.

### CROSS-REFERENCE TO RELATED APPLICATIONS

This application claims the benefit under 35 U.S.C. §119(a) of Korean Patent Application No. 10-2010-0124228, filed on Dec. 7, 2010, in the Korean Intellectual Property Office, the disclosure of which is incorporated herein in its entirety by reference for all purposes.

### BACKGROUND

1. Field

The following description relates to reflective color filters, and reflective color display apparatuses and methods of a color display employing the same.

2. Description of the Related Art

Generally, a color may be formed using three primary colors which are red, green, and blue (RGB). To form a color with RGB, three colored light beams (a red color light beam, a green color light beam, and a blue color light beam) may be superimposed. A conventional color display apparatus may display color by dividing an area of a fixed three primary-color filter and transmitting or reflecting light on the divided areas of the fixed three primary-color filter.

The conventional color display apparatus may use an absorption type color filter which transmits only a desired color and absorbs the other colors. In the conventional color display apparatus, for example, loss of light passing through the absorption type color filter may be large which may affect a display image. Also, since the absorption type color filter may be used by dividing the area when a primary color or a color close to the primary color is displayed, light passing through other color areas may be completely blocked out. As such, more light may be lost when using the absorption type color filter and thus, affecting the overall display image.

Thus, when the absorption type color filter is used in a reflective color display apparatus, a loss ratio of the absorption type color filter is generally too large with respect to its reflective characteristics. As such, it becomes difficult to display a bright color when using the absorption type color filter.

As an alternative to the absorption type color filter, a color filter using a photonic crystal having reflective characteristics in which the color filter may be capable of reflecting a color corresponding to a photonic band gap and transmitting other colors has been studied. For example, a primary color displayed with a photonic crystal may be a shiny and bright color that may not be displayed by the conventional color filter. However, although a photonic crystal color filter may be capable of solving the problem of large light loss of a reflective color display apparatus using an absorption type color filter, a three primary color display principle may still be used to display the color areas on a color coordinate that a user recognizes. Therefore, color loss may still arise with respect to an area-division of a color filter employing the three primary color display principle.

### SUMMARY

In one general aspect, there is provided a reflective color filter which include first and second photonic crystal areas which reflect light in a selection wavelength band from external light and include tunable photonic crystal which tunes a photonic band gap corresponding to a frequency bandwidth reflecting light through stimulation, and a controller which provides stimulations to the first and second photonic crystal areas to adjust the photonic band gap of the tunable photonic crystal of the first and second photonic crystal areas.

The reflective color filter may further include an absorption plate disposed under the first and second photonic crystal areas.

The first and second photonic crystal areas may include the tunable photonic crystal so that at least one of a shape, a volume, and an effective refractive index of each of the first and second photonic crystal areas may be changed by an external stimulation to change a central frequency of the photonic band gap.

The first and second photonic crystal areas may be arrayed side-by-side in a horizontal direction.

The reflective color filter may further include a photonic crystal panel including the first and second photonic crystal areas formed in each area corresponding to a pixel of a display apparatus to have a 2-dimensional (2D) array of the first and second photonic crystal areas.

The first and second photonic crystal areas may overlap.

The reflective color filter may further include a first photonic crystal panel including the first photonic crystal area in each area corresponding to a pixel of a display apparatus and a second photonic crystal panel including the second photonic crystal area in each area corresponding to a pixel of the display apparatus, so that the first and second photonic crystal panels overlap.

In another aspect, there is provided a reflective color display apparatus which include a reflective color filter which includes first and second photonic crystal areas and a controller, and a 2D array of an area including the first and second photonic crystal areas corresponding to a pixel, wherein the first and second photonic crystal areas reflect light of a selection wavelength band from external light and include tunable photonic crystal capable of tuning a photonic band gap corresponding to a frequency bandwidth reflecting light through a stimulation, and the controller provides stimulations to the first and second photonic crystal areas to adjust the photonic band gap of the tunable photonic crystal of the first and second photonic crystal areas, and a shutter which changes transmissivity of light to variably adjust amounts of lights incident onto the first and second photonic crystal areas.

The reflective color display apparatus may further include a photonic crystal panel including the first and second photonic crystal areas which are arrayed side-by-side in a horizontal direction and formed in each area corresponding to a pixel to have a 2D array of a pair of the first and second photonic crystal areas.

The reflective color display apparatus may further include a first photonic crystal panel including the first photonic crystal area in each area corresponding to a pixel and a second photonic crystal panel including the second photonic crystal area in each area corresponding to a pixel, so that the first and second photonic crystal panels overlap, wherein the shutter may include a first shutter located on a side onto which external light is incident and a second shutter located between the first and second photonic crystal panels to overlap with the first and second photonic crystal panels.

The reflective color filter may further include an absorption plate disposed under the first and second photonic crystal areas.

The first and second photonic crystal areas may include the tunable photonic crystal so that at least one of a shape, a volume, and an effective refractive index of each of the first and second photonic crystal areas is changed by an external stimulation to change a central frequency of the photonic band gap.

In yet another aspect, there is provided a method of a color image display using a reflective color display apparatus including providing stimulations to first and second photonic crystal areas of the reflective color apparatus to tune a photonic band gap of a tunable photonic crystal of the first and second photonic areas and driving a shutter to variably adjust the amounts of the lights incident onto the first and second photonic crystal areas.

The reflective color display apparatus may include a photonic crystal panel which includes first and second photonic crystal areas arrayed side-by-side in a horizontal direction and formed in each area corresponding to a pixel to have a 2D array of a pair of the first and second photonic crystal areas.

The reflective color display apparatus may include a first photonic crystal panel comprising the first photonic crystal area in each area corresponding to a pixel and a second photonic crystal panel including the second photonic crystal area in each area corresponding to a pixel, so that the first and second photonic crystal panels overlap, wherein the shutter includes a first shutter located on a side onto which external light is incident and a second shutter located between the first and second photonic crystal panels to overlap with the first and second photonic crystal panels.

The first and second photonic crystal areas include the tunable photonic crystal so that at least one of a shape, a volume, and an effective refractive index of each of the first and second photonic crystal areas may be changed by an external stimulation to change a central frequency of the photonic band gap.

The reflective color filter further includes an absorption plate disposed under the first and second photonic crystal areas.

The controller may independently provide stimulations to the first and second photonic crystal areas to adjust the photonic band gap of the tunable photonic crystal of the first and second photonic crystal areas so that a desired color through a combination of selection wavelength bands reflected from the first and second photonic crystal areas may be displayed.

In yet another aspect, there is provided a method of displaying a color image using a reflective color filter having first and second photonic crystal areas, the method include reflecting, via the first and second photonic crystal areas having a tunable photonic crystal, light in a selection bandwidth from an external light, and providing stimulations to the first and second photonic crystal areas to adjust a photonic gap of the tunable photonic crystal so that the tunable photonic crystal reflects light having a desired wavelength to display a desired color.

The method may further include driving a shutter to variably adjust an amount of light incident onto the first and second photonic crystal areas.

In yet another aspect, there is provided a reflective color filter which may include a photonic crystal area to reflect light in a selection wavelength band from external light, the photonic crystal area comprising a tunable photonic crystal to tune a photonic band gap corresponding to a frequency bandwidth reflecting light through stimulation, and a controller to provide stimulation to the photonic crystal area to adjust the photonic band gap of the tunable photonic crystal of the photonic crystal area to display a desired color through a combination of selection wavelength bands reflected from the photonic crystal area.

In yet another aspect, there is provided a display apparatus including a reflective color filter provided in a housing of the display apparatus, the reflective color filter including first and second photonic crystal areas which reflect light in a selection wavelength band from external light and comprise a tunable photonic crystal which tunes a photonic band gap corresponding to a frequency bandwidth reflecting light through a stimulation, and a controller which provides stimulations to the first and second photonic crystal areas to adjust the photonic band gap of the tunable photonic crystal of the first and second photonic crystal areas.

Other features and aspects may be apparent from the following detailed description, the drawings, and the claims.

### BRIEF DESCRIPTION OF THE DRAWINGS

FIG. 1 is a diagram illustrating structures of a reflective color filter and a reflective color display apparatus employing the reflective color filter, according to an example embodiment.

FIG. 2 is a diagram illustrating color coordinates, showing possible combinations of color coordinates displaying a white color.

FIG. 3 is a diagram illustrating a color coordinate model that is simplified as a semicircular model.

FIG. 4 is a diagram illustrating a method of displaying a color of a color area that is displayed at the brightest brightness and a color of a color area that is not displayed at the brightest brightness.

FIG. 5 is a diagram illustrating a reflective color filter having an overlap type structure and a reflective color display apparatus employing the reflective color filter, according to another example embodiment.

FIG. 6 is a diagram illustrating an existing structure that divides a pixel area into three pixel areas and displays colors of the three pixel areas with a three primary color filter.

FIG. 7 is a diagram illustrating a structure that divides a pixel area displaying a color of an area-division type variable pixel into two pixel areas so as to correspond to FIG. 1.

FIG. 8 is a diagram illustrating a structure in which two variable pixels overlap each other to achieve a color display of an overlap type variable pixel so as to correspond to FIG. 5.

FIG. 9 is a graph illustrating a brightness characteristic of a color display apparatus according to the color display methods of FIGS. 6 through 8.

Throughout the drawings and the detailed description, unless otherwise described, the same drawing reference numerals will be understood to refer to the same elements, features, and structures. The relative size and description of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

A reflective color filter, and a reflective color display apparatus employing the same may use a variable color tunable photonic crystal capable of changing a photonic band gap area in real time through an external stimulation. According to the reflective color filter and the reflective color display apparatus and method that will be described below, a display color may be changed along a curve approximate to an edge of a color coordinate corresponding to a full primary color using the tunable photonic crystal. Also, arbitrary dots on a display color curve may be displayed in an analog form through a driving circuit.

All colors on a color coordinate system may be displayed through an appropriate mixture ratio of three primary colors on a three primary color display coordinate. To display all colors including white and black colors that a user recognizes on a color coordinate system, an arbitrary dot on the color coordinate may be displayed through a mixture of two colors at which a straight line passing a desired color coordinate meets a display color curve. Differently from the conventional three primary color display method by which fixed three primary colors are determined, when the above-described color display method is used, an arbitrary color on the color coordinate may be displayed through two colors. As such, loss of light in a color filter may be reduced due to a three-area division principle. Since examples of the method of displaying the color coordinate through two colors may include various types of methods, a driving circuit may be configured to select a color display combination of displaying a maximum brightness through selections of an appropriate driving mechanism and a color display algorithm.

The reflective color display apparatus according to an example embodiment may display clearer and brighter primary colors and combination colors than the conventional reflective color display apparatus using the absorption type color filter. Therefore, the reflective color display apparatus may be capable of displaying a shiny, bright color display providing a more natural world appearance and view to a user that cannot be expressed by conventional transmissive and reflective display apparatuses. Also, the reflective color display apparatus according to an example embodiment of the present invention may use external light as a light source. As such, the reflective color display apparatus may contribute to the development of color display apparatuses that consume less power and may have more simplified structures.

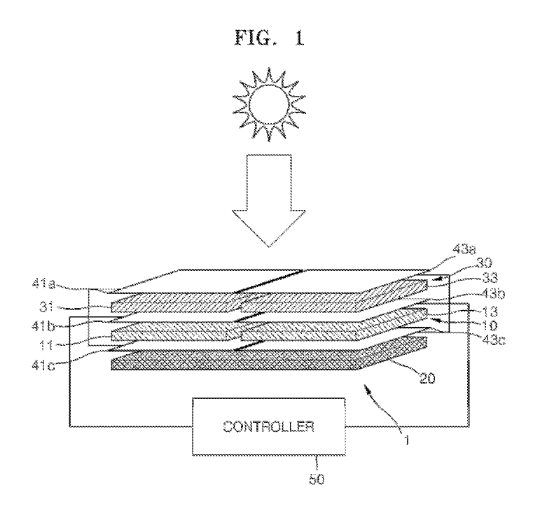

FIG. 1 illustrates structures of a reflective color filter and a reflective color display apparatus employing the reflective color filter, according to an example embodiment.

Referring to FIG. 1, the reflective color display apparatus includes a reflective color filter 1 and a shutter 30 which may variably tune an amount of light incident onto the reflective color filter 1. The reflective color filter 1 includes a photonic crystal panel 10 and a controller 50. The photonic crystal panel 10 includes first and second photonic crystal areas 11 and 13 to reflect light in a selection wavelength band from external light. The controller 50 provides an external stimulation to the first and second photonic crystal areas 11 and 13 of the photonic crystal panel 10 to control a photonic band gap of a photonic crystal. Photonic crystals, for example, may be periodic dielectric structures that have a band gap that may prevent propagation of a certain frequency range of light. As such, a user may be capable of controlling light more efficiently when using photonic crystals.

The reflective color filter 1 may reflect all of the light in a selected wavelength band and transmit light of other wavelength bands. Therefore, the reflective color filter 1 may not require a reflective minor that is generally required when an absorption color filter is used. However, the reflective filter 1 may include an absorption plate 20 having a black color. The absorption plate 20 blocks an upward reflection of a complementary colored light passed through the reflective color filter 1. The absorption plate 20 may be included in the reflective color filter 1 or the reflective color display apparatus.

The shutter 30 may variably change a transmissivity of the light to variably adjust the amounts of lights respectively incident onto the first and second photonic crystal areas 11 and 13 of the photonic crystal panel 10. In other words, the shutter 30 may include first and second shutter areas 31 and 33 that respectively adjust the amounts of the lights incident onto the first and second photonic crystal areas 11 and 13.

For non-limiting illustration purposes, FIG. 1 illustrates the reflective color filter 1 and the shutter 30 located in an area corresponding to one pixel of the reflective color display apparatus. The photonic crystal panel 10 may include the first and second photonic crystal areas 11 and 13 that are arranged side-by-side in a horizontal direction for each pixel. When the photonic crystal panel 10 is applied to the reflective color display apparatus, the reflective color filter 1 may include the photonic crystal panel 10 that includes the pair of the first and second photonic crystal areas 11 and 13 that are 2-dimensionally arrayed to correspond to a 2-dimensional (2D) pixel array of the reflective color display apparatus. In other words, in the reflective color filter 1, the photonic crystal panel 10 may have a 2-D array of the pair of the first and second photonic crystal areas 11 and 13 so that the first and second photonic crystal areas 11 and 13 are located in each area corresponding to one pixel of the reflective color display apparatus. Accordingly, the shutter 30 may include each pair of shutter areas in each pixel to adjust the amounts of the lights respectively incident onto the first and second photonic crystal areas 11 and 13 located in each pixel. In other words, the shutter 30 may have a 2-D array of the pair of the first and second shutter areas 31 and 33 corresponding to the 2-D array of the pair of the first and second photonic crystal areas 11 and 13.

In FIG. 1, the first and second photonic crystal areas 11 and 13 are arrayed side-by-side in the horizontal direction but may be arrayed to have an overlap structure as described below with reference to FIG. 5.

In the photonic crystal panel 10, the first and second photonic crystal areas 11 and 13 may include a tunable photonic crystal, (that is, a variable color tunable photonic crystal). The tunable photonic crystal may be provided so that a photonic band gap corresponding to a frequency bandwidth reflecting light through stimulation is tuned.

A shape, a size, or an effective refractive index of the tunable photonic crystal may vary with external electric or mechanical variations so that the tunable photonic crystal may tune the photonic band gap corresponding to the frequency bandwidth reflecting light.

The tunable photonic crystal may vary the photonic band gap from an infrared light to an ultraviolet light according to an external stimulation. A color filter, which becomes transparent when a photonic band gap of such a tunable photonic crystal is used under an ultraviolet or infrared area, may be embodied.

The tunable photonic crystal applied to the first and second photonic crystal areas 11 and 13, for example, may be photonic crystals distributed in nanoparticle crystal of a high refractive index that is dielectric within a peripheral environment in which a volume varies due to infiltration of an electrolyte caused by a reversible oxidoreduction reaction induced by a voltage.

The controller 50 independently provides stimulations to each of the first and second photonic crystal areas 11 and 13 of the photonic crystal panel 10 to adjust the photonic band gap of the tunable photonic crystals of the first and second photonic crystal areas 11 and 13. As a result, a desired color may be displayed through a combination of selection wavelengths reflected from the first and second photonic crystal areas 11 and 13.

In FIG. 1, electrodes 41a, 41b, 41c, 43a, 43b, and 43c are provided above the shutter 30, between the shutter 30 and the photonic crystal panel 10, and under the photonic crystal panel 10. Thus, the electrodes 41a, 41b, 41c, 43a, 43b, and 43c electrically connect between the controller 50, the shutter 30, and the photonic crystal panel 10 to one another so that the shutter 30 and the photonic crystal panel 10 are controlled by the controller 50. The electrodes 41a, 41b, 41c, 43a, 43b, and 43c are provided to correspond to the arrays of the pair of the first and second shutter areas 31 and 33 of the shutter 30 and the pair of the first and second photonic crystal areas 11 and 13 of the photonic crystal panel 10. As mentioned above, the pair of the first and second shutter areas 31 and 33 of the shutter 30 and the pair of the first and second photonic crystal areas 11 and 13 of the photonic crystal panel 10 constitute one pixel of the reflective color display apparatus. In FIG. 1, the electrodes 41b and 43b located between the shutter 30 and the photonic crystal panel 10 may be commonly used. Alternatively, an electrode positioned under the shutter 30 and an electrode positioned above the photonic crystal panel 10 may be separately provided.

As described above, the reflective color display apparatus may include the reflective color filter 1 including one photonic crystal panel 10 and one shutter 30. Also, the photonic crystal panel 10 and the shutter 30 may be provided so that two photonic crystal areas and two shutter areas are provided in one pixel to correspond to one another.

According to the reflective color display apparatus, stimulations are independently provided to each the first and second photonic crystal areas 11 and 13 of the photonic crystal panel 10 of the reflective filter 1 so that the reflective color display apparatus may display a color image. Therefore, the photonic band gap of the tunable photonic crystals of the first and second photonic crystal areas 11 and 13 may be tuned by reflecting a light of a desired wavelength. When the photonic band gap is being tuned, the shutter 30 may be driven to variably adjust the amounts of the lights incident onto the first and second photonic crystal areas 11 and 13, thereby displaying a desired color image to a desired brightness.

A principle of realizing a desired color through the photonic crystal panel 10 including the first and second photonic crystal areas 11 and 13 independently tuned in each pixel may be described as follows.

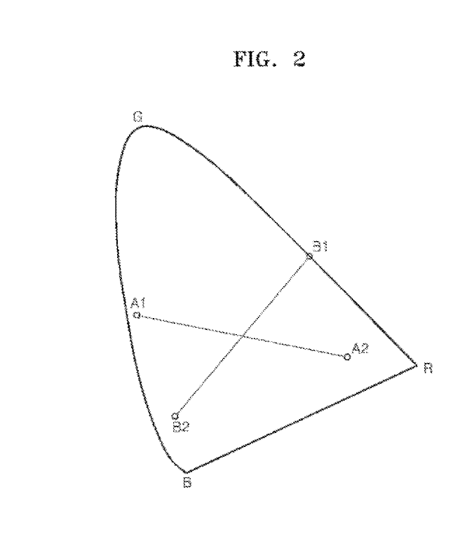

FIG. 2 illustrates color coordinates, showing possible combinations of color coordinates displaying a white color. In FIG. 2, R, G, and B respectively denote red, green, and blue colors that are three primary colors.

Referring to FIG. 2, when arbitrary dots on the color coordinate system are to be displayed by a combination of particular colors, two primary colors corresponding to vertexes of a line segment (for example, A1, A2 and B1, B2) may at least be provided. When a color is displayed through a combination of two colors, there may exist various methods for selecting primary colors.

Therefore, in contrast to providing only a linear combination determined to display an arbitrary color coordinate as in the conventional three primary color model, an optimal one of possible two color linear combinations may be selected. As such, the brightest of the color combinations may be selected. The following two points may be considered, for example, to obtain more favorable display characteristics.

First, several primary color combinations are possible to display the same color coordinate but these combinations may have different brightness characteristics from one another. Therefore, the brightest combination may be selected among the primary color combinations.

Secondly, a color change amount of a variable device such as, for example, a variable color tunable photonic crystal device, may be proportional to a response speed thereof. Therefore, when a display color changes from one color to another color, it may be considered that shortening of a movement length of a color coordinate is more favorable for a moving picture display.

FIG. 3 illustrates a color coordinate model that is simplified as a semicircular model. In FIG. 3, color ranges of possible two color pixels capable of displaying an arbitrary inner color coordinate are shown. A left end of the semicircular model of FIG. 3 denotes a blue color B limit, and a right end denotes a red color R limit. In FIG. 3, a° and b° denote arbitrary values from the B limit and the R limit, respectively. Here, a two color pixel, for example, indicates that one pixel may be divided into two color areas.

As shown in FIG. 3, a straight line passing an arbitrary dot in a semi-circle may have an arbitrary value in a range reaching from a left end (the B limit) of the semi-circle to a right end (the R limit) of the semi-circle.

Here, based on a desired color coordinate, a ratio between lengths of a left line segment and a right line segment of the desired color coordinate monotone decreases as a left dot of a line segment moves from the B limit to a green color, and only one combination having a color coordinate at the center of the line segment exists.

In a reflective type color display apparatus, the brightest brightness that a color display device may display with respect to incident light may be fixed by reflectivity. Therefore, to adjust a ratio between intensities of colors in a two color pixel, a reflection intensity of one device may be reduced so that the other device is dark. It is favorable that relative brightness of two colors is to be most similar to each other to obtain the brightest brightness on a desired color coordinate. Thus, a pixel combination having the brightest brightness on a provided color coordinate is marked with a dashed line in FIG. 3.

Accordingly, when a color is displayed so that a desired color coordinate is shown in a center of a line segment formed by the color of the two color pixels to obtain the brightest brightness, only the color of the two color pixels with respect to the desired color coordinate may be determined. Thus, when a color display algorithm is realized using this method, a color display device displaying the brightest brightness may be obtained.

However, all color areas may be not displayed using this method.

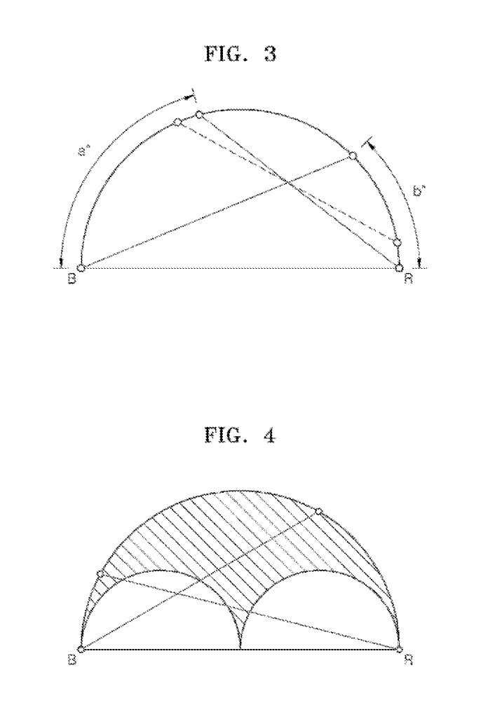

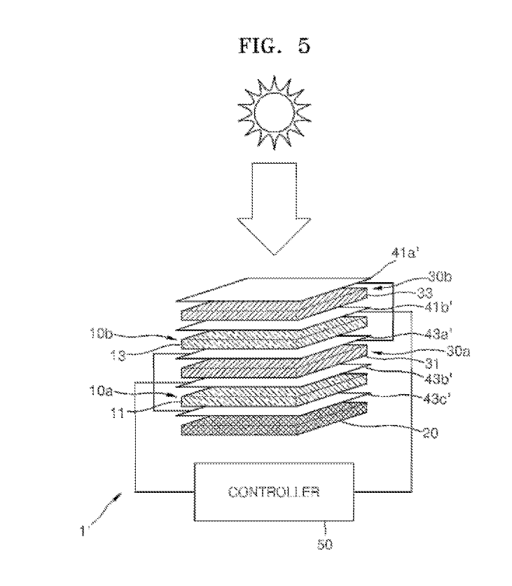

FIG. 4 illustrates a method of color display of a color area that is displayed at the brightest brightness and a color area that is not displayed at the brightest brightness. In FIG. 4, an area of a large semi-circle indicated with diagonal lines corresponds to a color area that is displayed at the brightest brightness, and two small semi-circles correspond to a color area that is not displayed at the brightest brightness.

An area that is not displayed with a central coordinate may be displayed as follows.

In other words, when a color coordinate to be displayed is located in a left quarter circle area of a semi-circle, one of two color pixels is fixed to a B limit, and only a reflection intensity of the one pixel may be adjusted. Also, the other one of the two color pixels may be displayed by changing only a color of another quarter semi-circle (between green and red colors) corresponding to the other pixel without a change of reflectivity thereof.

When the color coordinate is located in a right quarter circle area (between red and green colors), one of the two color pixels is fixed to the R limit, and only a reflection intensity thereof may be adjusted. Also, only a color of the other one of the two color pixels may be changed between red and green color areas without changing the reflection intensity.

When a color area is displayed using the above-described method, brightness may be slightly reduced.

As described above, when all color coordinates in a color coordinate area are displayed by linear combinations, change of a relative intensity between two primary colors may be required. The first and second shutter areas 31 and 33 of the shutter 30 for adjusting an intensity of light are located above the first and second photonic crystal areas 11 and 13 constituting two color pixels. Therefore, when a reflective color filter and a reflective color display apparatus are configured as shown in FIG. 1, all colors in a color coordinate are displayed using two color pixels.

As described above, the first and second photonic crystal areas 11 and 13 constituting one pixel may be arrayed side-by-side in the horizontal direction. As such, the reflective color filter 1 and the shutter 30 may be provided in an area-division structure. However, examples in which the first and second photonic crystal areas 11 and 13 constituting one pixel in an arrayed side-by-side manner in the horizontal direction should not be limited thereto. For example, the reflective color filter 1 and the reflective color display apparatus may use a photonic crystal characteristic of reflecting only light corresponding to a selected photonic band gap area and transmitting other lights upwards. Therefore, the reflective filter may be arrayed in an overlap manner in a light incident direction.

For example, a combination color in which a component of a color located in a lower part is darker than a color located in an upper part, may not be displayed in the conventional color filter. In other words, the brightness of the color in the lower part may be further reduced due to the overlapping structure of the conventional color filter. Thus, since the color filter arrays having different color combinations are arranged side-by-side to constitute one group, a structure of the conventional color filter may be complicated and the color display results from use of the conventional color filter arrayed in an overlap manner may be considerably offset. However, the color filter according to an example of the present embodiment may solve the above-mentioned problems when color variance occurs in the color filter. Therefore, an overlap type reflective color filter and a reflective color display apparatus employing the same may be realized with the combinations as shown in FIG. 5.

FIG. 5 illustrates a reflective color filter 1′ having an overlap type structure and a reflective color display apparatus employing the reflective color filter 1′. In FIG. 5, elements having the same or similar functions as those elements of FIG. 1 are denoted by the same reference numerals, and their repeated descriptions are omitted.

Referring to FIG. 5, the reflective color display apparatus includes the reflective color filter 1′ and a shutter. The reflective color filter 1′ includes first and second photonic crystal panels 10a and 10b that overlap with each other and a controller 50. The shutter includes a first shutter 30a that is located between the first and second photonic crystal panels 10 and 10b and a second shutter 30b that is located on a side on which external light is incident. Therefore, the shutter may variably adjust the amounts of lights incident onto the first and second photonic crystal panels 10a and 10b.

In the overlap structure shown in FIG. 5, the first and second photonic crystal panels 10a and 10b of the reflective color filter 1′ respectively include an array of first photonic crystal areas 11 and an array of second photonic crystal areas 13. The first and second photonic crystal panels 10a and 10b form an overlap structure. The controller 50 an external stimulation to the first and second photonic crystal areas 11 and 13 of the first and second photonic crystal panels 10a and 10b to adjust a photonic band gap of photonic crystals.

The first shutter 30a includes a first shutter area 31 that variably changes transmissivity of light to variably adjust an amount of light incident onto the first photonic crystal area 11 of the first photonic crystal panel 10a. The second shutter 30b includes a second shutter area 33 that variably changes transmissivity of light to variably adjust an amount of light incident onto the second photonic crystal area 13 of the second photonic crystal panel 10b.

As shown in FIG. 5, the first photonic crystal panel 10a, the first shutter 30a, the second photonic crystal panel 10b, and the second shutter 30b may sequentially overlap with one another. An absorption plate 20 having a black color may be located under the first photonic crystal panel 10a to block an upward reflection of a complementary colored light having passed through the first photonic crystal area 11. As described above, the absorption plate 20 may be included as a component of the reflective color filter 1′ or the reflective color display apparatus.

In the above-described overlap structure, the first and second photonic crystal areas 11 and 13 and the first and second shutter areas 31 and 33 may have sizes corresponding to one pixel. Also, the first photonic crystal area 11, the first shutter area 31, the second photonic crystal area 13, and the second shutter area 33 may overlap with one another in one pixel.

For non-limiting illustration purposes, only structures of the first and second photonic crystal panels 10a and 10b and the first and second shutters 30a and 30b in an area corresponding to one pixel of the reflective color display apparatus are shown in FIG. 5. When the first and second photonic crystal panels 10a and 10b and the first and second shutters 30a and 30b are applied to the reflective color display apparatus, the first and second photonic crystal panels 10a and 10b may overlap with each other so that the first and second photonic crystal areas 11 and 13 are 2-dimensionally arrayed in the reflective color filter 1′ to correspond to a 2-D pixel array of the reflective color display apparatus. In other words, in the reflective color filter 1′, the first photonic crystal panel 10a may have a 2D array of the first photonic crystal area 11 so that the first photonic crystal area 11 is located in each area corresponding to one pixel of the reflective color display apparatus. The second photonic crystal panel 10b may have a 2D array of the second photonic crystal area 13 so that the second photonic crystal area 13 is located in each area corresponding to one pixel of the reflective color display apparatus. Also, for example, one first shutter 30a may be provided in each pixel to adjust the amount of the light incident onto the first photonic crystal area 11 located to correspond to each pixel. One second shutter 30b may be provided in each pixel to adjust the amount of the light incident onto the second photonic crystal area 13 located to correspond to each pixel. In other words, the first shutter 30a may have a 2-D array of the first shutter area 31 to correspond to the 2D array of the first photonic crystal area 11, and the second shutter 30b may have a 2D array of the second shutter area 33 to correspond to the 2D array of the second photonic crystal area 13.

According to the reflective color filter 1′ and the overlap structure of the first and second shutters 30a and 30b, the reflective color filter 1′ may have a structure in which a pair of photonic crystal panels, including one photonic crystal area in each pixel, overlap with each other. Similarly, the reflective color display apparatus may have a structure in which a pair of photonic crystal panels, including one photonic crystal area in each pixel, overlap with each other. The reflective color display apparatus may also include in the structure a shutter, including one shutter area in each pixel, on each photonic crystal panel.

The controller 50 may independently provide stimulations to the first and second photonic crystal areas 11 and 13 of the first and second photonic crystal panels 10a and 10b to adjust a photonic band gap of tunable photonic crystals of the first and second photonic crystal areas 11 and 13. Therefore, a desired color may be displayed through a combination of selection wavelengths reflected from the first and second photonic crystal areas 11 and 13.

Electrodes 41a′, 41b′, 43a′, 43b′, and 43c′ may be respectively provided above the second shutter 30b, between the second shutter 30b and the second photonic crystal panel 10b, between the second photonic crystal panel 10b and the first shutter 30a, between the first shutter 30a and the first photonic crystal panel 10a, and under the first photonic crystal panel 10a. Therefore, the electrodes 41a′, 41b′, 43a′, 43b′, and 43c′ may electrically connect the controller 50, the first and second shutters 30a and 30b, and the first and second photonic crystal panels 10a and 10b to one another so that the first and second shutters 30a and 30b and the first and second photonic crystal panels 10a and 10b are controlled by the controller 50. The electrodes 41a′, 41b′, 43a′, 43b′, and 43c′ may be provided to correspond to an array of the first shutter area 31 of the first shutter 30a, the second shutter area 33 of the second shutter 30b, the first photonic crystal area 11 of the first photonic crystal panel 10a, and the second photonic crystal area 13 of the second photonic crystal panel 10b constituting one pixel. In FIG. 5, the electrodes 43b′, 43a′, 41b′ respectively located between the first photonic crystal panel 10a and the first shutter 30a, between the first shutter 30a and the second photonic crystal panel 10b, and between the second photonic crystal panel 10b and the second shutter 30b are commonly used. However, in example embodiment, for example, electrodes above and under the first shutter 30a, an electrode under the second shutter 30b, an electrode above the first photonic crystal panel 10a, and electrodes above and under the second photonic crystal panel 10b may be separately provided.

According to the above-described reflective color display apparatus, stimulations may be independently provided to the first and second photonic crystal areas 11 and 13 of the first and second photonic panels 10a and 10b of the reflective color filter 1′ to display an image. Therefore, the photonic band gap of the tunable photonic crystals of the first and second photonic crystal areas 11 and 13 may be tuned in a state capable of reflecting only light having a desired wavelength. In this tuned state, the first and second shutters 30a and 30b may be driven to variably adjust the amounts of the lights incident onto the first and second photonic crystal areas 11 and 13, thereby displaying a desired color image at a desired brightness.

As described above, according to the reflective color filter 1′ and the reflective color display apparatus, brightness of a color may be improved over the conventional color display method employing the three primary color pixel display principle.

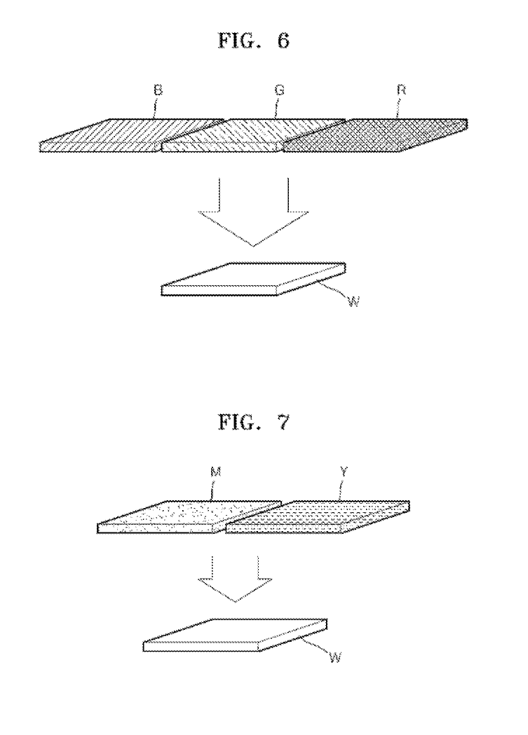

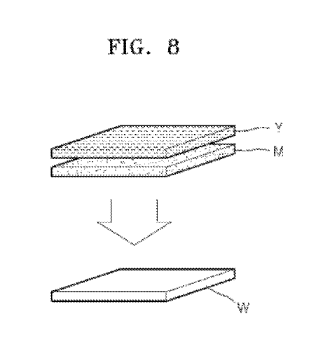

FIG. 6 illustrates an existing structure that divides a pixel area into three areas and displays colors areas with a three primary color filter. FIG. 7 illustrates a structure that divides a pixel area to achieve a color display of an area-division type variable pixel into two areas so as to correspond to FIG. 1. FIG. 8 illustrates a structure in which two variable pixels overlap each other to achieve a color display of an overlap type variable pixel so as to correspond to FIG. 5.

As shown in FIG. 6, when one pixel area is divided into three areas and R, G, and B color elements are disposed, each R, G, and B color may occupy ⅓ of the whole spectrum band, brightness of a primary color may be limited to 1/9 of an incident white color, and brightness of the white may also be limited to ⅓ of the incident white color. This brightness, for example, may correspond to a result where each R, G, and B color occupies ⅓ of the whole spectrum band and thus, may be substantially reduced. As shown in FIG. 6, for example, when each R, G, and B color occupies about ⅓ of the whole spectrum band, the one pixel area may denote a white W color.

As shown in FIG. 7, when one pixel area is divided into two areas, and spectrum bandwidths for displaying the same primary color are equal to each other, brightness of the primary color may be ⅓ of an incident white color, and brightness of the white may also be ⅓ of the incident white color as a result of the spectrum width of the one pixel area being divided into two areas. Therefore, the brightness of the primary color in the color filter according to the present embodiment may increase three times in comparison with the brightness of the conventional three primary color filter and thus, a shiny and bright color may be displayed. The brightness of the white color may depend on a spectrum width when the one pixel area is area-divided does into two areas. As such, the brightness of the white color may not vary. However, a spectrum width of a color display apparatus may be variably adjusted to improve brightness of a white color. As shown in FIG. 7, for example, when each of any two of Yellow Y, Magenta M and Cyan C, occupy ½ of the whole spectrum band, the one pixel area may denote a white W color.

As shown in FIG. 8, when a color filter including color variable pixels is used in an overlap manner, a color variable range of each of the upper and lower parts of the color filter may reach from a B color to an R color. Therefore, in comparison to the brightness results as described in FIG. 7, brightness of a primary color may be equivalent to the case of an area-division with the one pixel being divided into two areas, but brightness of a combination color and brightness of a white color may be improved by two times in comparison with the case of the area-division. In other words, for example, the brightness of the primary color is ⅓ of an incident white color, and the brightness of the white is ⅔ of the incident white color. As shown in FIG. 8, for example, when each of any two of Yellow Y, Magenta M and Cyan C occupy ½ of the whole spectrum band, the one pixel area may denote a white W color.

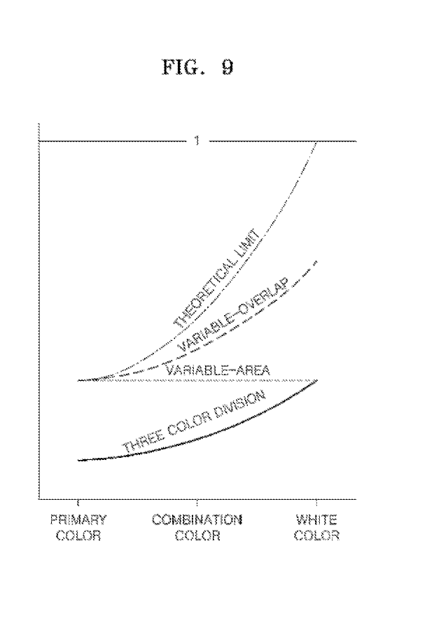

FIG. 9 is a graph illustrating a brightness characteristic of a color display apparatus according to the color display methods of FIGS. 6 through 8.

As shown in FIG. 9, in comparison with the conventional three color division method, when a color filter is configured to enable a color variation, brightness of a primary color may be improved by at least two times, and brightness of a combination color may also be improved. Further, when the color filter is used in an overlap manner, brightness of a white color may be improved.

According to one or more aspects, reflective color filters using a tunable photonic crystal to reduce color loss caused by an area-division, and reflective color display apparatuses and methods for a color display employing the same are provided.

According to an example reflective color filter, reflective color display apparatus and method of a color display employing the example reflective color filter, brightness of a primary color may be improved by, for example, two times, and a brightness of a combination color may be improved in comparison with the conventional three color division method. Also, a color variable filter may be used in an overlap manner to improve brightness of a white color.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein.

As a non-exhaustive illustration only, a reflective color filter described herein may be used in display apparatuses such as a camcorder, cellular phone, a personal digital assistant (PDA), a digital camera, a portable game console, and an MP3 player, a portable/personal multimedia player (PMP), a handheld e-book, a portable lab-top PC, a global positioning system (GPS) navigation, and devices such as a desktop PC, a high definition television (HDTV), an optical disc player, a setup box, and the like.

A number of examples have been described above. Nevertheless, it will be understood that various modifications may be made. For example, suitable results may be achieved if the described techniques are performed in a different order and or if components in a described system, architecture, device, or circuit are combined in a different manner and/or replaced or supplemented by other components or their equivalents. Accordingly, other implementations are within the scope of the following claims.

What is claimed is:

1. A reflective color filter, comprising:
first and second photonic crystal areas which reflect light in a selection wavelength band from external light and comprise a tunable photonic crystal which tunes a photonic band gap corresponding to a frequency bandwidth reflecting light through a stimulation; and
a controller which provides stimulations to the first and second photonic crystal areas to adjust the photonic band gap of the tunable photonic crystal of the first and second photonic crystal areas.

2. The reflective color filter of claim 1, further comprising:
an absorption plate disposed under the first and second photonic crystal areas.

3. The reflective color filter of claim 1, wherein the first and second photonic crystal areas comprise the tunable photonic crystal so that at least one of a shape, a volume, and an effective refractive index of each of the first and second photonic crystal areas is changed by an external stimulation to change a central frequency of the photonic band gap.

4. The reflective color filter of claim 1, wherein the first and second photonic crystal areas are arrayed side-by-side in a horizontal direction.

5. The reflective color filter of claim 4, further comprising:
a photonic crystal panel comprising the first and second photonic crystal areas formed in each area corresponding to a pixel of a display apparatus to have a 2-dimensional (2D) array of the first and second photonic crystal areas.

6. The reflective color filter of claim 1, wherein the first and second photonic crystal areas overlap.

7. The reflective color filter of claim 6, further comprising:
a first photonic crystal panel comprising the first photonic crystal area in each area corresponding to a pixel of a display apparatus and a second photonic crystal panel comprising the second photonic crystal area in each area corresponding to a pixel of the display apparatus, so that the first and second photonic crystal panels overlap.

8. A reflective color display apparatus, comprising:
a reflective color filter which comprises first and second photonic crystal areas and a controller, and a 2D array of an area comprising the first and second photonic crystal areas corresponding to a pixel,
wherein the first and second photonic crystal areas reflect light of a selection wavelength band from external light and comprise a tunable photonic crystal capable of tuning a photonic band gap corresponding to a frequency bandwidth reflecting light through a stimulation, and the controller provides stimulations to the first and second photonic crystal areas to adjust the photonic band gap of the tunable photonic crystal of the first and second photonic crystal areas; and
a shutter which changes transmissivity of light to variably adjust amounts of lights incident onto the first and second photonic crystal areas.

9. The reflective color display apparatus of claim 8, further comprising:
a photonic crystal panel comprising the first and second photonic crystal areas which are arrayed side-by-side in a horizontal direction and formed in each area corresponding to a pixel to have a 2D array of a pair of the first and second photonic crystal areas.

10. The reflective color display apparatus of claim 8, further comprising:
a first photonic crystal panel comprising the first photonic crystal area in each area corresponding to a pixel; and
a second photonic crystal panel comprising the second photonic crystal area in each area corresponding to a pixel, so that the first and second photonic crystal panels overlap,
wherein the shutter comprises a first shutter located on a side onto which external light is incident and a second shutter located between the first and second photonic crystal panels to overlap with the first and second photonic crystal panels.

11. The reflective color display apparatus of claim 8, wherein the reflective color filter further comprises an absorption plate disposed under the first and second photonic crystal areas.

12. The reflective color display apparatus of claim 8, wherein the first and second photonic crystal areas comprise the tunable photonic crystal so that at least one of a shape, a volume, and an effective refractive index of each of the first and second photonic crystal areas is changed by an external stimulation to change a central frequency of the photonic band gap.

13. A method of a color image display using a reflective color display apparatus, comprising:
providing stimulations to first and second photonic crystal areas of the reflective color apparatus to tune a photonic band gap of a tunable photonic crystal of the first and second photonic areas; and
driving a shutter to variably adjust the amounts of the lights incident onto the first and second photonic crystal areas.

14. The method of claim 13, wherein the reflective color display apparatus comprises a photonic crystal panel which comprises first and second photonic crystal areas arrayed side-by-side in a horizontal direction and formed in each area corresponding to a pixel to have a 2D array of a pair of the first and second photonic crystal areas.

15. The method of claim 13, wherein the reflective color display apparatus comprises a first photonic crystal panel comprising the first photonic crystal area in each area corresponding to a pixel and a second photonic crystal panel comprising the second photonic crystal area in each area corresponding to a pixel, so that the first and second photonic crystal panels overlap,
wherein the shutter comprises a first shutter located on a side onto which external light is incident and a second shutter located between the first and second photonic crystal panels to overlap with the first and second photonic crystal panels.

16. The method of claim 13, wherein the first and second photonic crystal areas comprise the tunable photonic crystal so that at least one of a shape, a volume, and an effective refractive index of each of the first and second photonic crystal areas is changed by an external stimulation to change a central frequency of the photonic band gap.

17. The method of claim 13, wherein the reflective color filter further comprises an absorption plate disposed under the first and second photonic crystal areas.

18. The reflective filter of claim 1, wherein the controller independently provides stimulations to the first and second photonic crystal areas to adjust the photonic band gap of the tunable photonic crystal of the first and second photonic crystal areas so that a desired color through a combination of selection wavelength bands reflected from the first and second photonic crystal areas is displayed.

19. The reflective color display apparatus of claim 8, wherein the controller independently provides stimulations to the first and second photonic crystal areas to adjust the photonic band gap of the tunable photonic crystal of the first and second photonic crystal areas so that a desired color through a combination of selection wavelength bands reflected from the first and second photonic crystal areas is displayed.

20. A method of color image display using a reflective color filter having first and second photonic crystal areas, comprising:
reflecting, via the first and second photonic crystal areas having a tunable photonic crystal, light in a selection bandwidth from an external light; and
providing stimulations to the first and second photonic crystal areas to adjust a photonic gap of the tunable photonic crystal so that the tunable photonic crystal reflects light having a desired wavelength to display a desired color.

21. The method of claim 20, further comprising:
driving a shutter to variably adjust an amount of light incident onto the first and second photonic crystal areas.

22. A reflective color filter, comprising:
a photonic crystal area to reflect light in a selection wavelength band from external light, the photonic crystal area comprising a tunable photonic crystal to tune a photonic band gap corresponding to a frequency bandwidth reflecting light through stimulation; and
a controller to provide stimulation to the photonic crystal area to adjust the photonic band gap of the tunable photonic crystal of the photonic crystal area to display a desired color through a combination of selection wavelength bands reflected from the photonic crystal area.

23. A display apparatus, comprising:
a reflective color filter provided in a housing of the display apparatus, the reflective color filter comprising;
first and second photonic crystal areas which reflect light in a selection wavelength band from external light and comprise a tunable photonic crystal which tunes a photonic band gap corresponding to a frequency bandwidth reflecting light through a stimulation; and
a controller which provides stimulations to the first and second photonic crystal areas to adjust the photonic band gap of the tunable photonic crystal of the first and second photonic crystal areas.
